(19) United States
(12) Patent Application Publication
(10) Pub. No.: US 2025/0236019 A1
(43) Pub. Date: Jul. 24, 2025

(54) SYSTEM AND METHOD FOR AN AUTONOMOUS MOBILE FACTORY

(71) Applicant: GRITT ROBOTICS, San Carlos, CA (US)

(72) Inventors: Vishal Dugar, San Francisco, CA (US); Puneet Puri, San Carlos, CA (US); Felipe Roz Barscevicius, Woodside, CA (US); Anirudh Vemula, San Francisco, CA (US)

(21) Appl. No.: 19/034,132

(22) Filed: Jan. 22, 2025

Related U.S. Application Data
(60) Provisional application No. 63/623,964, filed on Jan. 23, 2024.

(51) Int. Cl. B25J 9/16

(52) U.S. Cl. CPC B25J 9/1687; B25J 9/1669; B25J 9/1682

(57) ABSTRACT

An autonomous mobile factory includes: a container; bins arranged within the container and configured to store parts associated with an installation structure; a robotic assembly; and a controller. The controller is configured to: access an instruction associated with assembly of the installation structure; select a part specified in the instruction; identify a bin containing the part; define an assembly toolpath for maneuvering the part from the bin to the assembly station; and derive a grasp pose, aligning the part with the assembly toolpath, for retrieving the part from the bin. The controller is further configured to, via the robotic assembly: trigger a robotic arm to retrieve the part from the bin in the grasp pose; maneuver the robotic arm according to the assembly toolpath to locate the part at the assembly station in the grasp pose; and couple the part to a second part at the assembly station.

### CROSS-REFERENCE TO RELATED APPLICATIONS

This application claims the benefit of U.S. Provisional Application No. 63/623,964, filed on 23 Jan. 2024, which is hereby incorporated in its entirety by this reference.

This application is related to U.S. Non-Provisional application Ser. No. 18/799,439, filed on 9 Aug. 2024, which is hereby incorporated in its entirety by this reference.

### TECHNICAL FIELD

This invention relates generally to the field of solar installations and, more specifically, to a new and useful system and method for an autonomous mobile factory in the field of solar installations.

### BRIEF DESCRIPTION OF THE FIGURES

FIGS. 1A and 1B are a schematic representation of an autonomous mobile factory.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. SYSTEM: MOBILE FACTORY

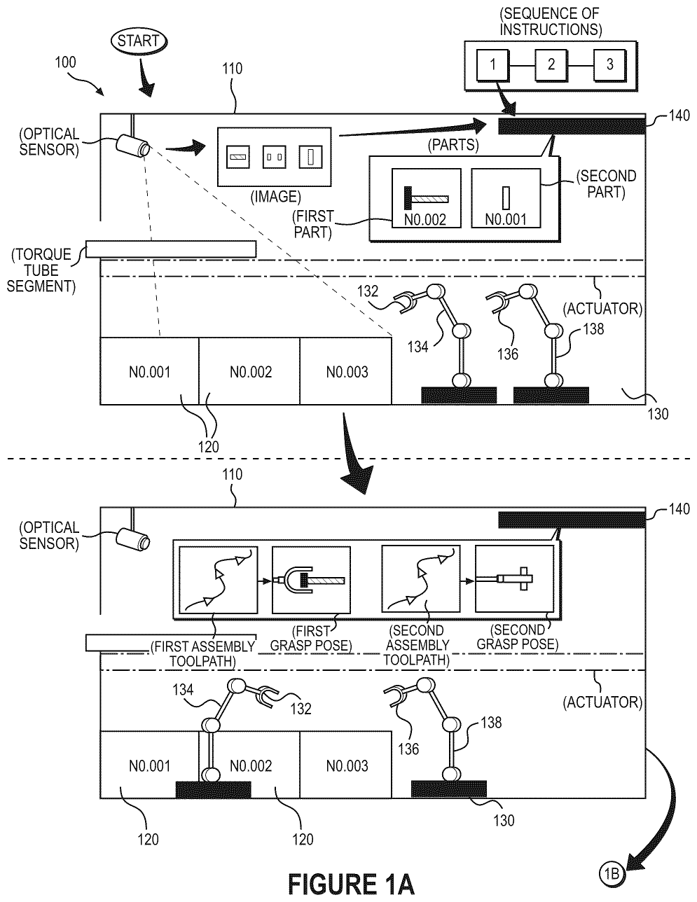

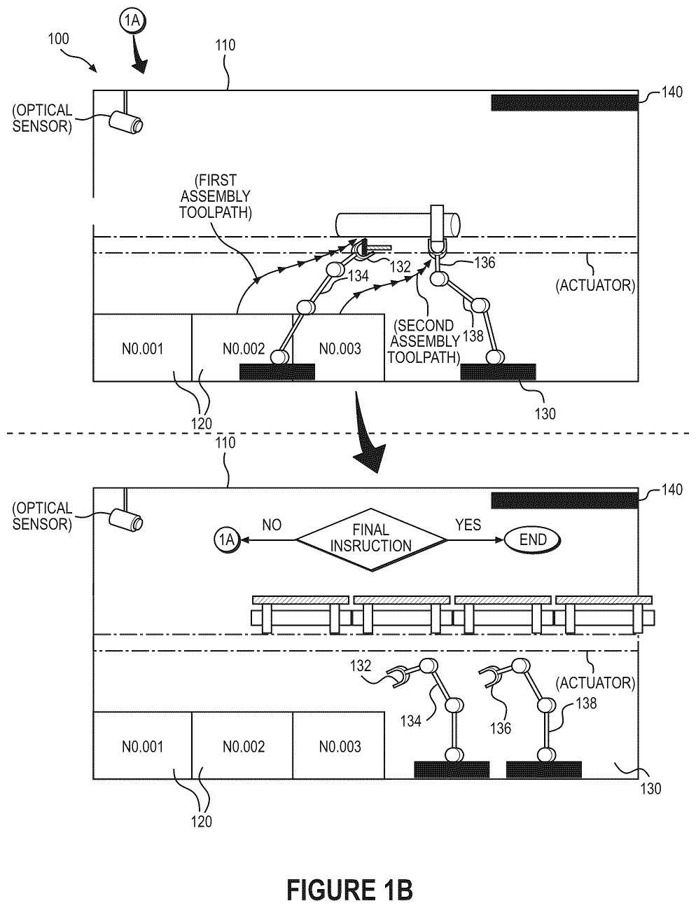

As shown in FIGS. 1A and 1B, an autonomous mobile factory 100 for autonomously assembling a solar installation includes: a container 110 (e.g., a shipping container); a set of bins 120 (e.g., stackable modular bins, automated storage bins); and a robotic assembly 130.

The container 110 is configured for delivery to a jobsite, such as by a container truck, a tracked utility vehicle, an articulated hauler, etc.

The set of bins 120 are arranged within the container 110 and configured to store a set of parts (e.g., torque tubes, mounting brackets, fasteners, photovoltaic panels) of a target component assembly for a solar power plant (or a “solar farm”).

The robotic assembly 130 includes: a first end effector 132 (e.g., an adaptive gripper, a parallel-jaw gripper) configured to transiently retain parts (e.g., mounting brackets, torque tube segments) stored within the set of bins 120; a first robotic arm 134 configured to manipulate the first end effector 132 to withdraw parts from the set of bins 120 toward a first assembly station within the container 110; a second end effector 136 (e.g., a driver) configured to transiently retain parts (e.g., fasteners, nuts) stored within the set of bins 120; and a second robotic arm 138, arranged adjacent the first robotic arm 134, and configured to manipulate the second end effector 136 to withdraw parts from the set of bins 120 toward the first assembly station.

### 1.1 Controls: Assembly of Solar Installation

In one variation, shown in FIGS. 1A and 1B, the autonomous mobile factory 100 further includes a controller 140 configured to, following delivery of the container 110 proximal a target installation zone on a jobsite: access a sequence of instructions associated with assembly of the target component assembly and designated for the target installation zone; identify a first bin, in the set of bins 120, containing a first part (e.g., a fastener) specified by a first instruction in the sequence of instructions; and identify a second bin, in the set of bins 120, containing a second part (e.g., a mounting bracket) specified by the first instruction.

The controller 140 is further configured to, based on the first instruction: define (e.g., generate, derive) a first assembly toolpath for maneuvering the first part from the first bin to the first assembly station within the container 110; and define a second assembly toolpath for maneuvering the second part from the second bin to the first assembly station and assembling the second part to the first part.

The controller 140 is also configured to: derive a first grasp pose for retrieving the first part from the first bin, the first grasp pose exposing a first mating surface of the first part; and derive a second grasp pose for retrieving the second part from the second bin, the second grasp pose exposing a second mating surface of the second part, the first instruction specifying assembly of the second mating surface against the first mating surface.

The controller 140 is further configured to, via the robotic assembly 130: trigger the first robotic arm 134 to retrieve the first part, via the first end effector 132, from the first bin according to the first grasp pose; navigate the first robotic arm 134 according to the first assembly toolpath to locate the first part at the first assembly station; trigger the second robotic arm 138 to retrieve the second part, via the second end effector 136, from the second bin according to the second grasp pose; and navigate the second robotic arm 138 according to the second assembly toolpath to locate the second part at the first assembly station, and to couple the first part to the second part to complete a first assembly operation at the first assembly station according to the first instruction.

### 1.2 Iterative Assembly

In one variation, the controller 140 is also configured to: repeat the steps described above for each instruction, in the sequence of instructions, to complete assembly of a first instance of the target component assembly within the container 110; and, via the robotic assembly 130, trigger the first robotic arm 134 to maneuver the first instance of the target component assembly toward an outlet of the container 110 for installation within the target installation zone.

### 2. APPLICATIONS

Generally, the autonomous mobile factory 100 functions as a self-contained modular assembly unit (or “factory-in-a-box”) configured to autonomously assemble components for a solar installation (e.g., photovoltaic panel arrays, torque tube assemblies, or tracking systems) scheduled for installation across a jobsite, such as hundreds or thousands of acres of non-uniform outdoor terrain to form a large solar plant (or “solar farm”). More specifically, multiple instances of the autonomous mobile factory 100 can be deployed to local installation zones on the jobsite to ingest bins or pallets of (discrete) components and to autonomously assemble the components in preparation for construction of solar arrays within their local installation zones.

In particular, an instance of the autonomous mobile factory 100 can: access a sequence of instructions for assembling a target component assembly designated for installation within a local installation zone; derive assembly paths for retrieving and coupling parts (e.g., torque tubes, mounting brackets, photovoltaic panels) within the container 110 according to the sequence of instructions; and trigger a robotic assembly 130—contained within the container 110—to execute these assembly paths in order to autonomously assemble an instance of this target component assembly proximal the target installation zone within the outdoor environment.

Thus, rather than human operators manually assembling instances of the target component assembly prior to construction of a solar array across a (large) jobsite, instances of the autonomous mobile factory 100: can be dropped in local installation zones on the jobsite; and can automate assembly of component assemblies for construction in their nearby installation zones. Each autonomous mobile factory 100 can therefore: reduce labor requirements across the jobsite by reducing need for (skilled) human operators to manually assemble instances of the solar installation; and accelerate project timelines by executing lights-out, local, and accurate completion of component assemblies before and/or while solar arrays are constructed nearby including these component assemblies.

### 2.1 Autonomous Mobile Factory

In one implementation, the autonomous mobile factory 100 includes: a container 110 (e.g., a shipping container), such as deliverable by a skid-steer loader, a tracked excavator, or a wheeled utility vehicle to a local installation zone on a jobsite; a set of bins 120 configured to store a set of parts (e.g., torque tubes, mounting brackets, photovoltaic panels, fasteners) associated with assembly of a target component assembly (e.g., photovoltaic panel arrays, torque tube assemblies, or tracking systems); a robotic assembly 130 configured to retrieve parts from this set of bins 120 and assemble these parts—within the container 110—according to instructions for assembling a solar installation specified in the sequence of instructions; a set of optical sensors (e.g., color cameras, LiDAR sensors, depth cameras) configured to capture images depicting part locations and alignment within the container 110 in order to track part retrieval, placement, and integration during an assembly cycle; and a controller 140 configured to execute the sequence of instructions for assembling instances of the target component assembly by coordinating robotic assembly 130 operations, deriving assembly paths for part handling, and monitoring real-time feedback from optical sensors to maintain efficiency during assembly processes within the container 110.

In this implementation, the robotic assembly 130 can include: an end effector 132 (e.g., a vacuum gripper, magnetic gripper, adaptive gripper) configured to transiently retain parts (e.g., torque tubes, mounting brackets, fasteners) during retrieval and placement operations of an assembly cycle; a robotic arm (e.g., an articulated multi-axis arm or a gantry-mounted arm) configured to maneuver the end effector 132 within the container 110 for retrieving parts from the set of bins 120 and positioning these parts at designated assembly stations within the container 110; and a set of actuators (e.g., linear actuators, rotary actuators, or servo-driven elevators) configured to control the movement of the robotic arm and facilitate positioning and handling of parts during the assembly process.

In one example, prior to initiating an assembly cycle to assemble instances of the target component assembly within the autonomous mobile factory 100, a remote computer system can: access a site plan representing designated installation zones across an outdoor environment; identify a target installation zone, represented in the site plan, designated for deployment of instances of a target component assembly; access an inventory list of parts currently loaded across a fleet of autonomous mobile factories 100 arranged at a designated loading zone at the outdoor environment; and detect a primary autonomous mobile factory 100, in the fleet of autonomous mobile factories 100, currently ready for deployment based on the inventory list of parts. Accordingly, the remote computer system can then: trigger autonomous loading of the primary autonomous mobile factory 100 onto a designated off-road vehicle at the loading zone; generate a prompt requesting an operator to navigate the off-road vehicle, and therefore the primary autonomous mobile factory 100 proximal the target installation zone; and serve this prompt to the operator, such as by serving this prompt to a mobile device (e.g., a tablet) associated with the operator.

The system can then, as described below, autonomously assemble multiple instances of a target component assembly (e.g., photovoltaic panel arrays, torque tube assemblies, or tracking systems) within the container 110 proximal the target installation zone for deployment across target installation locations within the target installation zones.

Therefore, the autonomous mobile factory 100 can function as a self-contained modular assembly unit configured to: autonomously assemble instances of target component assemblies (e.g., photovoltaic panel arrays, torque tube assemblies, tracking systems) within a controlled environment in order to maintain repeatability of assembly processes; and facilitate on-site deployment by assembling solar installation components proximal target installation zones, thereby reducing logistical complexities, labor requirements, and project timelines in large-scale solar farm projects.

### 2.2 Solar Installation Assembly

In one implementation, following navigation of the container 110 proximal a target installation zone at the outdoor environment, the autonomous mobile factory 100 can then initiate assembly cycles to assemble instances of the target component assembly proximal the target installation zone. In this implementation, the autonomous mobile factory 100 can: access a sequence of instructions associated with assembly of the target component assembly; select a primary part (e.g., a torque tube segment) and a secondary part (e.g., mounting bracket) specified in a primary instruction, in the sequence of instructions; and implement inventory management techniques (e.g., RFID-based tracking, barcode scanning, weight sensors, or vision-based inventory detection, automated vision systems with integrated artificial intelligence) to identify a primary bin, in the set of bins 120, containing the primary part and to identify a secondary bin, in the set of bins 120, containing the secondary part.

Additionally, the autonomous mobile factory 100 can implement artificial intelligence techniques (e.g., path planning algorithms, reinforcement learning) to: derive a primary assembly toolpath for maneuvering the primary part from the primary bin to a primary assembly station within the container 110; and derive a secondary assembly toolpath for maneuvering the secondary part from the secondary bin to the primary assembly station and coupling the secondary part to the primary part according to the primary instructions.

The autonomous mobile factory 100 can then, via the robotic assembly 130, execute the primary assembly toolpath and the secondary assembly toolpath to complete a primary assembly phase—for assembly of a target component assembly—specified in the primary instruction. For example, the autonomous mobile factory 100 can derive assembly toolpaths for coupling a mounting bracket to a torque tube segment and, via the robotic assembly 130, execute these assembly toolpaths, such as by: locating the mounting bracket at a target installation zone on the torque tube via a primary robotic arm 134; and triggering a secondary robotic arm 138 to couple (e.g., via bolts tightened with a torque-controlled end effector) the mounting bracket to the torque tube segment.

The autonomous mobile factory 100 can then repeat the steps described above for each instruction, in the sequence of instructions, to assemble an instance of the target component assembly proximal the target installation zone. Therefore, the autonomous mobile factory 100 can: autonomously assemble instances of target component assemblies (e.g., photovoltaic panel arrays, torque tube assemblies) proximal designated installation zones, reducing reliance on manual labor and minimizing errors associated with manual assembly methods; and improve operational efficiency by leveraging assembly toolpaths and robotic assemblies to accelerate assembly cycles of a target component assembly, thus maintaining timely deployment of these solar installations across large-scale solar farm projects.

### 4. AUTONOMOUS MOBILE FACTORY

Generally, the autonomous mobile factory 100 functions as a self-contained modular assembly unit (or “factory-in-a-box”) configured to autonomously assemble a solar installation (e.g., photovoltaic panel arrays, torque tube assemblies, or tracking systems) designated for deployment at a non-uniform outdoor terrain (e.g., e.g., a solar farm with uneven, rocky, or sloped landscapes).

In one implementation, the autonomous mobile factory 100 includes: a container 110 (e.g., a shipping container); a set of bins 120 configured to store a set of parts (e.g., torque tube segments, mounting brackets, solar panels, fasteners) associated with assembly of a solar installation; a robotic assembly 130 configured to autonomously retrieve parts from this set of bins 120, such as via an end effector 132 (e.g., a gripper) coupled to a robotic arm, and autonomously assemble these parts—within the container 110—according to instructions for assembling parts of the solar installation; a set of optical sensors (e.g., types of optical sensors) configured to capture images depicting part locations across the set of bins 120 and to monitor alignment and placement of these parts during assembly of the solar installation within the container 110; and a controller 140 configured to retrieve instructions, such as from a remote computer system, for assembling the parts into the solar installation and to define assembly toolpaths for manipulating the parts, via the robotic assembly 130, to assemble the solar installation within the container 110.

In this implementation, the autonomous mobile factory 100 can further include: a power supply (e.g., onboard solar panels, rechargeable batteries, hybrid generators) configured to supply power to components (e.g., robotic arms, optical sensors, controller) arranged within the container 110; a suite of communication modules (e.g., wireless transceivers) configured to transmit real-time data (e.g., component inventory levels, assembly progress, fault diagnostics, and environmental conditions) from the autonomous mobile factory 100 to an external computer system, such as a remote computer system associated with an operator designated to oversee deployment of the solar installations across the non-uniform outdoor terrain; and a chute (e.g., automated guide rails, sliding conveyer chutes) configured to output a solar installation—assembled within the container 110—toward an exterior staging area proximal an installation location.

Accordingly, the autonomous mobile factory 100 can define a portable, automated assembly unit that: can deploy at an outdoor terrain (e.g., uneven, rocky, or sloped surfaces) and operate in diverse environmental conditions with minimal setup time; and reduces labor requirements to fulfill installment of solar installations across an outdoor terrain by automating time-intensive assembly tasks (e.g., torque tube alignment, bracket installation, and photovoltaic panel mounting).

### 4.1 Container

In one implementation, the autonomous mobile factory 100 includes a container 110 configured to transiently install at an off-road vehicle (e.g., a skid-steer loader, a tracked excavator, a wheeled utility vehicle) for traversing non-uniform outdoor terrains, such as rocky, muddy, or sloped environments.

In one example, following navigation of the off-road vehicle to a loading area, a remote computer system can: select an autonomous mobile factory 100 for loading onto the off-road vehicle, such as by selecting a container 110 at the loading area based on a preloading inventory (e.g., torque tubes, brackets, solar panels) available within the container 110; and trigger a crane (e.g., an automated lift) to load this container onto the off-road vehicle for deployment to an installation location at the non-uniform outdoor terrain.

In another implementation, the autonomous mobile factory 100: includes a self-propulsion system (e.g., integrated tracked wheels, articulated legs, motorized undercarriages) coupled to the container 110; and configured to autonomously navigate the container 110—via the self-propulsion system—across the non-uniform outdoor terrain, such as to autonomously navigate to an installation location at the outdoor terrain.

For example, the autonomous mobile factory 100 can: include an integrated tracked mobility system (e.g., caterpillar tracks, hybrid track-wheel systems) coupled to the container 110 and configured to maneuver across diverse terrains, such as rocky surfaces, mud, and steep inclines; and implement autonomous navigation techniques (e.g., artificial intelligence-driven path planning, simultaneous localization and mapping) to autonomously navigate the container 110—via the integrated tracked mobility system—to an installation location at the outdoor terrain while dynamically avoiding obstacles (e.g., large boulders, trenches, debris, or uneven ground) through real-time sensor inputs from a suite of sensors (e.g., LiDAR, depth cameras, and ultrasonic proximity detectors) coupled to an exterior of the container 110.

Therefore, the autonomous mobile factory 100 can: reduce cycle times for deployment of solar installations across a designated installation site (e.g., solar farm) efficiency by eliminating the need for external transport vehicles and manual intervention to transport parts (e.g., torque tubes, mounting brackets) to a target installation location at the installation site; and reduce operational delays and resources associated with non-uniform terrain of the installation site by autonomously assembling these parts into a target component assembly proximal the target installation zone.

### 4.2 Bins

In one implementation, the autonomous mobile factory 100 can include a set of bins 120 (e.g., e.g., modular bins, stackable bins, or automated storage bins) configured to store parts (e.g., torque tubes, mounting brackets) associated with assembly of a target component assembly. In this implementation, each bin in the set of bins 120: defines a self-contained storage module configured to securely store a particular part (e.g., a torque tube) within the container 110 in order to prevent damage and/or misalignment of this particular part during transport of the container 110 and/or during assembly of the target component assembly within the container 110; and is configured to load onto the container 110 via an exterior interface of the container 110, such as via a guided rail system, automated lift mechanism, and/or fork-lift compatible slots.

In another implementation, the autonomous mobile factory 100 can receive torque tubes from an external source rather than storing them within the container 110. In this implementation, the computer system can coordinate independent transport of a bundle of torque tubes 130 from an external storage location to the factory 100 and position the bundle of torque tubes 130 at an ingress interface of the container 110, such as: via an automated conveyor system 140 configured to sequentially deliver torque tubes to the assembly line; a robotic arm interface 150 configured to transfer torque tubes into designated assembly positions; and/or a manual loading station 160 enabling operator-controlled placement of torque tubes into the container 110.

Additionally, the autonomous mobile factory 100 can implement inventory management techniques (e.g., RFID-based tracking, barcode scanning, weight sensors, or vision-based inventory detection) to: detect a quantity of a particular part (e.g., torque tube segments) within a particular bin as falling below a target quantity; generate a prompt—specifying the part type and a target quantity of parts—requesting an operator to load additional parts into this particular bin; and serve this prompt to the operator, such as by serving the prompt at an integrated display associated with the operator (e.g., a touchscreen interface, heads-up display, or handheld device).

In one example, the set of bins 120 can include: a primary bin containing torque tube segments associated with assembly of a structural support framework for the solar installation; a secondary bin containing mounting brackets associated with assembly of the connections between torque tubes and photovoltaic panels; and a tertiary bin containing fasteners (e.g., bolts, screws, or rivets) and associated with assembly of both the structural framework and the attachment of solar panels to the mounting brackets.

Therefore, the autonomous mobile factory 100 can include a set of bins 120 that: supplies assembly parts to the robotic assembly 130 within the container 110 to facilitate continuous operation during assembly of the target component assembly within the container 110; and enables an operator to seamlessly supply (or “reload”) additional parts into the container 110 via accessible exterior loading interfaces, thereby maintaining uninterrupted assembly workflows for the target component assembly.

### 4.3 Robotic Assembly

In one implementation, the autonomous mobile factory 100 can include a robotic assembly 130 including: an end effector 132 (e.g., a vacuum gripper, a magnetic gripper, an adaptive gripper) configured to transiently retain parts (e.g., torque tubes, mounting brackets, fasteners) stored across the set of bins 120; a robotic arm (e.g., an articulated multi-axis arm or a gantry-mounted arm) configured to manipulate the end effector 132 within the container 110 to retrieve parts across the set of bins 120 and position these parts at designated assembly locations within the container 110; and a set of actuators (e.g., linear actuators, elevators) configured to maneuver the robotic arm within the container 110.

In this implementation, the autonomous mobile factory 100 can include multiple (e.g., n-number) of instances of the robotic assembly 130 arranged within the container 110 in order to concurrently retrieve multiple parts across the set of bins 120 and concurrently position these parts at designated assembly locations within the container 110.

For example, the autonomous mobile factory 100 can include a primary robotic assembly 130 including: a primary end effector 132 defining a vacuum gripper configured to transiently retain a torque tube segment; and a primary robotic arm 134—such as arranged on a rotary actuator—configured to manipulate the end effector 132 within the container 110 to retrieve the torque tube segment from a primary bin and position the torque tube segment at an assembly station within the container 110. In this example, the autonomous mobile factory 100 can further include a secondary robotic assembly 130 including: a secondary end effector 136 defining a magnetic gripper configured to transiently retain a mounting bracket; a secondary robotic arm 138—such as arranged on a linear actuator—configured to manipulate the end effector 132 within the container 110 to retrieve the mounting bracket from a secondary bin; and position the mounting bracket at a target location within the container 110 for integration with the torque tube segment.

In another implementation, the autonomous mobile factory 100 includes a robotic assembly 130 including a linear actuator (e.g., a conveyor): extending across a length of the container 110, such as extending from an inlet (e.g., a loading bay with guided rails, an automated part feeder) arranged on a primary end of the container 110 to an outlet (e.g., an assembly station, a discharge chute) arranged on a secondary end, opposite the primary end, of the container 110; and configured to autonomously maneuver parts (e.g., torque tubes) fed (e.g., via a via a robotic arm or a material feeder) into the inlet of the container 110 across the container 110 for assembly of structural components (e.g., torque tube assemblies, bracket-mounted frameworks) associated with the target component assembly.

Therefore, the autonomous mobile factory 100 can include a robotic assembly 130 to: increase assembly efficiency of solar installations by executing concurrent manipulation of multiple parts (e.g., mounting brackets, torque tubes) via coordinated robotic assemblies, thereby reducing cycle times for assembling solar installation parts; and maintain operational scalability via the multiple robotic assembly 130 instances to support high-throughput manufacturing for large-scale solar installations.

### 4.4 Optical Sensors

In one implementation, the autonomous mobile factory 100 can include a set of optical sensors (e.g., high-resolution cameras, LiDAR sensors) arranged within the container 110 to define multiple fields of view of: the set of bins 120 to monitor part availability and placement within the container 110; assembly stations within the container 110 to verify alignment during assembly of these parts; and material handling pathways to detect potential obstructions or misplaced components during assembly of these parts. In this implementation, the autonomous mobile factory can identify types and locations of components, such as within bins, for autonomous assembly of a solar installation. In another implementation, the autonomous mobile factory 100 can include optical sensors arranged at the robotic assembly 130, such as coupled to a robotic arm of the robotic assembly 130, to deliver real-time feedback on part retrieval and positioning from the robotic assembly 130.

Thus, the autonomous mobile factory 100 can include a set of optical sensors to: maintain accurate manipulation of parts during an assembly cycle by continuously monitoring alignment and placement of these parts within the container 110; and track inventory levels and operational workflows within the container 110 to maintain uninterrupted assembly processes.

### 4.5 Autonomous Vehicle Integration+Outdoor Installation

In one implementation, the autonomous mobile factory 100 can then release instances of an assembled solar installation to an external autonomous vehicle—such as described in application Ser. No. 18/799,439—for deployment of these solar installations across target install locations within the target install zone. Thus, the autonomous mobile factory 100 can automate the transfer and deployment of assembled solar installations, thereby reducing manual intervention and accelerating installation processes of these solar installations across an outdoor environment.

### 5. SITE PLAN+PART INVENTORY

In one implementation, the autonomous mobile factory 100 can access a site plan (e.g., a digital terrain map, a site layout), such as from a remote computer system, representing designated installation zones across an outdoor environment. In this implementation, a remote computer system can: identify a target installation location in the site plan currently scheduled for deployment of multiple instances of a target component assembly; access an inventory list of required parts (e.g., torque tubes, mounting brackets) for the scheduled deployment at the target installation location; detect an autonomous mobile factory 100 currently operational and available for deployment to the target installation location based on the inventory list; generate a prompt requesting an operator to transport this autonomous mobile factory 100 to the target installation location; and serve the prompt to the operator.

In one example, the autonomous mobile factory 100 can: implement the site plan to dynamically adjust deployment and operation of the autonomous mobile factory 100 based on terrain features (e.g., slopes, obstacles, or designated restricted areas) at the target installation location; align assembly cycles with a specific layout of a designated installation zone to coordinate locations proximal the designated installation zone for deployment of the autonomous mobile factory 100; and transmit report status updates, such as progress on part assembly and detected inventory discrepancies, to the remote computer system.

Therefore, the autonomous mobile factory 100 can access the site plan to: coordinate locations for assembly of solar installations to maintain installation progress within a designated installation zone; and coordinate resource allocation and operational workflows based on the terrain, part availability, and scheduling requirements at the target installation location.

### 5.1 Operational Constraints

In one implementation, the autonomous mobile factory 100 can further access: a weather forecast, such as output from a weather forecast model, representing environmental conditions (e.g., precipitation, wind speeds, or temperature fluctuations) at the designated installation zone; and a labor resource model (e.g., a digital workforce allocation map or staffing matrix) representing the availability and location of personnel required for auxiliary tasks associated with the assembly or deployment processes. The autonomous mobile factory 100 can then, as described above, leverage this data to: configure assembly schedules and toolpaths to mitigate effects of adverse weather conditions in order to maintain uninterrupted operation for deployment of the solar installations across the designated installation zone; and align on-site tasks with labor resource availability to minimize delays and coordinate auxiliary activities (e.g., part replenishment, site preparation, inspections) according to a target timeline for deployment of the solar installations.

### 6. ASSEMBLY SPECIFICATION

In one implementation, during an assembly cycle proximal a designated installation zone, the autonomous mobile factory 100 can access an assembly specification (e.g., electronic document, paper document, audio/video media)—representing high-level predefined steps specifying order of assembly—associated with assembly of a target component assembly for deployment across installation zones of the designated installation zone. In this implementation, the assembly specification represents high-level steps for: retrieving parts (e.g., torque tubes, mounting brackets, photovoltaic panels) from specified bins within the container 110; locating these parts at designated assembly stations within the container 110; and coupling parts to form structural components (e.g., torque tube assemblies or bracket-mounted arrays) of the target component assembly. Accordingly, the autonomous mobile factory 100 can then: select a primary step in the sequence of steps; identify a primary part (e.g., a torque tube segment) associated with the target component assembly from this primary step; and identify a secondary part (e.g., a mounting bracket) associated with the target component assembly from this primary step.

For example, the autonomous mobile factory 100 can: select a primary step for coupling a mounting bracket to a torque tube segment at a designated assembly station; identify a primary part (e.g., a torque tube segment) required for completion of the primary step; and identify a secondary part (e.g., a mounting bracket) required for completion of the primary step.

Therefore, the autonomous mobile factory 100 can access a predefined sequence of high-level steps for assembling a target component assembly in order to: automate retrieval, positioning, and coupling of parts to form structural components of the target component assembly; and maintain consistent assembly processes at the designated installation zone aligned with project specifications and operational constraints for deployment of the solar installations.

### 6.1 Generating Instructions

In one implementation, the autonomous mobile factory 100 can: ingest a digital or paper-based assembly procedure for a target component assembly; identify steps specified in the digital assembly procedure; extract instructions (e.g., text-based or diagrammatic instructions) for each step in the procedure; aggregate other supportive content for these steps, such as part diagrams, end effector specifications, and/or videos depicting assembly of the target component assembly; compile this data into individual instructional blocks containing multi-format instructions (e.g., text, visual, or sensor-based) corresponding to specific actions within the assembly cycle for assembling the target component assembly; and order these instructional blocks or define a decision-making pathway for the robotic assembly 130 to assemble the target component assembly.

Upon receipt of this compiled assembly procedure, the controller 140 within the autonomous mobile factory 100 can: implement a generative transformer, as described below, to derive toolpaths for steps of the assembly procedure to trigger robotic actions during an assembly cycle; and dynamically serve guidance in select formats (e.g., visual guidance) to guide the robotic assembly 130 during each phase of the assembly process, such as according to: assembly specifications of the solar installation; system feedback during an assembly cycle; and/or specific operational constraints within the container 110.

### 7. Part Identification

In one implementation, during the assembly cycle, the autonomous mobile factory 100 can then implement inventory management techniques (e.g., RFID-based tracking, barcode scanning, weight sensors, or vision-based inventory detection) to: locate a primary bin, in the set of bins 120, containing the primary part (e.g., a torque tube segment) required for completion of the primary instruction; and locate a secondary bin, in the set of bins 120, containing the secondary part (e.g., a mounting bracket) required for completion of the primary instruction. In one example, the autonomous mobile factory 100 can: access an image captured by an optical sensor arranged within the container 110 and defining a field of view intersecting the set of bins 120; extract features from the image, such as part geometry, labels, or color patterns; and, based on these features, identify a location (e.g., coordinate location)—within the container 110—containing the primary part, such as by correlating the extracted features to a preloaded inventory database and/or by reading identifiers (e.g., barcodes, QR codes) affixed to the bins.

In another implementation, the autonomous mobile factory 100 can: detect absence of the primary part across the set of bins 120; and, in response to detecting the absence of this primary part, prompt an operator to manually inspect the parts loaded onto the container 110 and replenish this part at its designated bin in the set of bins 120 to maintain continuity of the assembly cycle within the container 110.

Therefore, the autonomous mobile factory 100 can: track locations of parts required for executing assembly instructions to maintain specific retrieval of these parts during each step of the assembly cycle; and update part inventories and their corresponding locations based on optical sensor feedback and assembly progress.

### 8. ASSEMBLY TOOLPATH

Generally, the autonomous mobile factory 100 can: implement toolpath planning techniques (e.g., artificial intelligence-driven path optimization, machine learning-based trajectory prediction, reinforcement learning for adaptive coupling strategies); and define an assembly toolpath—executable by the robotic assembly 130—to complete a primary installation phase specified in the primary instructions. More specifically, the autonomous mobile factory 100 can: define a primary assembly toolpath for maneuvering the primary part from the primary bin to the primary assembly station within the container 110; and define a secondary assembly toolpath for maneuvering the secondary part from the secondary bin to the primary assembly station and coupling the secondary part to the primary part.

### 8.1 Deriving Assembly Toolpath

In one implementation, the autonomous mobile factory 100 can: extract a predefined primary assembly toolpath from the primary instructions for maneuvering a primary part (e.g., a torque tube segment) from a primary bin to a target assembly station within the container 110; and extract a predefined secondary assembly toolpath from the primary instructions for maneuvering a secondary part (e.g., a mounting bracket) to the target assembly station for coupling to the primary part. In this implementation, the autonomous mobile factory 100 can then adjust these predefined assembly toolpaths, such as based on real-time feedback from: optical sensors (e.g., identifying unexpected part misalignments or obstacles); force sensors (e.g., detecting resistance during part movement or coupling operations); and dynamic environmental factors (e.g., vibration or container motion).

For example, the autonomous mobile factory 100 can: extract a predefined primary toolpath for maneuvering a torque tube segment to a designated assembly station within the container 110; and adjust this primary toolpath according to real-time optical feedback indicating a deviation in a location of the torque tube from a target location within the bin or its alignment along the predefined assembly axis at the designated assembly station within the container 110.

Therefore, the autonomous mobile factory 100 can maintain accurate part handling and alignment for an assembly cycle by dynamically adjusting assembly toolpaths based on real-time feedback, such as from optical sensors, force sensors, and environmental monitoring systems.

### 8.2 Generative Transformer Model: Generating Assembly Toolpath

In one implementation, the autonomous mobile factory system can: serve the primary instruction—in the sequence of instructions—to a generative transformer model (e.g., pre-trained transformer model) for execution; and receive, from the generative transformer model, an assembly toolpath specifying keypoints, traversable by the robotic assembly, for assembling the primary part to the second part. More specifically, the generative transformer model can implement natural language and vision processing techniques to: interpret a received input (i.e., the primary instruction) from the autonomous mobile factory; generate an output responsive to the received input that defines a sequence of steps, such as actional commands for the robotic assembly, that completes an assembly operation specified in the primary instruction and defines grasp poses for retrieving the primary part and secondary part and positioning these parts for coupling operations; and serve this sequence of steps and grasp poses to the autonomous mobile factory.

The generative transformer model can be trained based on: historical assembly data representing toolpaths, grasp poses, and coupling operations executed during previous assembly cycles for solar installation components; labeled datasets comprising sequences of instructions, corresponding to robotic commands, and real-world sensor feedback (e.g., optical sensor images, force sensor readings) captured during part retrieval, positioning, and coupling processes; simulated assembly scenarios generated through physics-based simulations, modeling variations in part geometries, bin arrangements, and environmental constraints; and reinforcement learning techniques, where the model iteratively optimizes toolpaths and robotic actions to minimize execution time, enhance accuracy, and maintain operational stability during assembly operations.

The autonomous mobile factory system can then implement toolpath planning techniques (e.g., artificial intelligence-driven path optimization, machine learning-based trajectory prediction, reinforcement learning for adaptive coupling strategies) to define an assembly toolpath according to the output from the generative transformer model (i.e., the sequence of steps, grasp poses) to complete a primary installation phase specified in the primary instructions, such as to assemble (or “couple”) a primary mating surface of a primary part to a secondary mating surface of the secondary part.

For example, the autonomous mobile factory system can: serve a primary instruction—in the sequence of instructions—to the generative transformer model specifying the coupling of a primary mating surface of a primary part (e.g., a torque tube segment) to a secondary mating surface of a secondary part (e.g., a mounting bracket). The generative transformer model can then: extract a sequence of steps from the primary instruction defining actionable commands for the robotic assembly to retrieve, position, and couple the primary part to the secondary part; derive a set of grasp poses for grasping the primary part and the secondary part by the robotic assembly to execute the sequence of steps; and serve the sequence of steps and the set of grasp poses to the autonomous mobile factory system. The autonomous mobile factory system can then: define an assembly toolpath for maneuvering the primary part and the secondary part along predefined trajectories to the target assembly station; and trigger the robotic assembly to execute this assembly toolpath in order to couple the primary mating surface of the primary part to the secondary mating surface of the secondary part, completing a primary installation phase for the primary instruction.

Therefore, the autonomous mobile factory can autonomously resolve for: variations in part configurations available within the container 110; adjustments for bin arrangements containing the set of parts; and dynamic responses to environmental constraints during assembly cycles.

### 9. GRASP POSE

In one implementation, the autonomous mobile factory 100 can derive a target grasp pose that exposes a mating surface (e.g., bore) of a part (e.g., a torque tube segment) in order to maintain alignment of the part according to an assembly toolpath during an assembly cycle at the assembly station within the container 110. In particular, the autonomous mobile factory 100 can implement grasp planning techniques (e.g., sensor-based pose estimation, feature-based grasping, simulation-driven grasping) to: derive a primary grasp pose of a primary part (e.g., a torque tube segment) that exposes a primary mating surface of the primary part; and derive a secondary grasp pose of a secondary part (e.g., a mounting bracket) that exposes a secondary mating surface of the secondary part configured to assemble (or “couple”) to the primary mating surface of the primary part as specified in the primary instruction.

In one example, the autonomous mobile factory 100 can: access an image captured by an optical sensor arranged within the container 110 and defining a field of view intersecting a primary bin containing a primary part (e.g., a torque tube segment); extract visual features from this image (e.g., edges, contours, surface markings); and calculate a current pose of the primary part (e.g., a torque tube segment) stored within the primary bin based on the visual features extracted from the image. The autonomous mobile factory 100 can then: detect misalignment between the current pose of the primary part and a target pose defined for the assembly toolpath; and, in response to the misalignment exceeding a threshold misalignment, derive a primary grasp pose—that exposes a primary mating surface of the primary part—for grasping the primary part (e.g., a torque tube) via the end effector 132.

Therefore, the autonomous mobile factory 100 can: trigger a robotic arm to grasp a part (e.g., a torque tube segment) from the set of bins 120 at a target grasp pose that exposes a mating surface of the part to support positioning and alignment of the part at a target assembly station within the container 110.

### 10. AUTONOMOUS COUPLING

In one implementation, the autonomous mobile factory 100 can then, via the robotic assembly 130: trigger a primary robotic arm 134 to retrieve the primary part (e.g., a torque tube segment), such as via a primary end effector 132, from the primary bin in the primary grasp pose; and maneuver the primary robotic arm 134 according to the primary assembly toolpath to locate the primary part at the primary assembly station within the container 110. Furthermore, the autonomous mobile factory 100 can: trigger a secondary robotic arm 138 to retrieve the secondary part (e.g., a mounting bracket), such as via a secondary end effector 136, from the secondary bin in the secondary grasp pose; maneuver the secondary robotic arm 138 according to the secondary assembly toolpath to locate the secondary part at the primary assembly station within the container 110; and couple the secondary part to the primary part in order to complete an installation phase for the primary instruction in the sequence of instructions.

Therefore, the autonomous mobile factory 100 can autonomously couple parts according to steps defined in a sequence of instructions while maintaining alignment, positioning accuracy, and operational consistency during the assembly cycle.

### 11. ITERATION: COMPLETING SEQUENCE OF INSTRUCTIONS

In one implementation, the autonomous mobile factory 100 can then: repeat the steps described above for each instruction, in the sequence of instructions, to complete assembly of a first instance of the target component assembly within the container 110; and, via the robotic assembly 130, trigger the first robotic arm 134 to maneuver the first instance of the target component assembly toward an outlet of the container 110 for deployment at the target installation zone.

### 12. CONCLUSION

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. An autonomous mobile factory for autonomously assembling a solar installation, the autonomous mobile factory comprising:
a container configured for delivery to a jobsite;
a set of bins arranged within the container and configured to store a set of parts of a target component assembly for a solar power plant;
a robotic assembly comprising:
a first end effector configured to transiently retain parts stored within the set of bins;
a first robotic arm configured to manipulate the first end effector to withdraw parts from the set of bins toward a first assembly station within the container;
a second end effector configured to transiently retain parts stored within the set of bins; and
a second robotic arm, arranged adjacent the first robotic arm, and configured to manipulate the second end effector to withdraw parts from the set of bins toward the first assembly station; and
a controller configured to, following delivery of the container proximal a target installation zone on a jobsite:
access a sequence of instructions associated with assembly of the target component assembly and designated for the target installation zone;
identify a first bin, in the set of bins, containing a first part specified by a first instruction in the sequence of instructions;
identify a second bin, in the set of bins, containing a second part specified by the first instruction;
based on the first instruction:
define a first assembly toolpath for maneuvering the first part from the first bin to the first assembly station within the container; and
define a second assembly toolpath for maneuvering the second part from the second bin to the first assembly station and assembling the second part to the first part;
derive a first grasp pose for retrieving the first part from the first bin, the first grasp pose exposing a first mating surface of the first part;
derive a second grasp pose for retrieving the second part from the second bin, the second grasp pose exposing a second mating surface of the second part, the first instruction specifying assembly of the second mating surface against the first mating surface; and
via the robotic assembly:
trigger the first robotic arm to retrieve the first part, via the first end effector, from the first bin according to the first grasp pose;
navigate the first robotic arm according to the first assembly toolpath to locate the first part at the first assembly station;
trigger the second robotic arm to retrieve the second part, via the second end effector, from the second bin according to the second grasp pose; and
navigate the second robotic arm according to the second assembly toolpath to:
locate the second part at the first assembly station; and
complete a first assembly operation at the first assembly station according to the first instruction.

2. The inventions as shown and/or described herein.
